(19) United States
(12) Patent Application Publication
(10) Pub. No.: US 2006/0109139 A1
(43) Pub. Date: May 25, 2006

(54) Remote-controlled in-vehicle device

(75) Inventors: Yoshinori Katsuta, Okazaki-city (JP); Hitomi Nagata, Kariya-city (JP); Kenichi Ogino, Toyota-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/268,543

(22) Filed: Nov. 8, 2005

(30) Foreign Application Priority Data
Nov. 8, 2004 (JP) 2004-323543

(51) Int. Cl. G08C 19/00; H04B 7/24

(52) U.S. Cl. 340/825.72; 455/39

(57) ABSTRACT

In a keyless entry system for a vehicle, an in-vehicle device controls door-lock or door-unlock according to a remote-controlling wireless signal from a transmitter. The in-vehicle device determines whether a demodulated signal compliant with a communications rule is obtained from the received wireless signal, and then whether authentication data included in the received wireless signal accords with that stored in the vehicle. The in-vehicle device stores a result of the determination as an analysis result of received electric waves. When a read-out request is received from a diagnosis tool, the stored analysis result is thereby outputted to the diagnosis tool. Based on the outputted analysis result, it is determined whether a cause of non-operation abnormality is a transmitting function of the transmitter or a receiving function of the in-vehicle device.

### CROSS REFERENCE TO RELATED APPLICATIONS

This application is based on and incorporates herein by reference Japanese Patent Application No. 2004-323543 filed on Nov. 8, 2004.

### FIELD

The present invention relates to a remote-controlled in-vehicle device that is mounted in a vehicle for remote-controlling door-lock, door-unlock, or the like using a transmitter unique to the vehicle.

### BACKGROUND

A keyless entry system is known as an example of a remote-controlled in-vehicle device that is mounted in a vehicle so that components in the vehicle are remote-controlled. This keyless entry system controls door-lock or door-unlock based on a remote-controlling wireless signal from a transmitter carried by a driver or a vehicle owner (refer to Patent Document 1, 2).

Patent Document 1: JP-2002-129794

Patent Document 2: JP-H9-41754

Here, a vehicular remote-controlled device such as the keyless entry system uses a wireless communications or electric waves. Therefore, when operating or manipulating of a transmitter does not control an in-vehicle device and non-operation abnormality thereby occurs, the cause of the abnormality is not easily determined. Namely, a user or even an automobile dealer mechanic cannot easily determine which of transmitter's transmission abnormality or recipient's reception abnormality has caused the non-operation abnormality.

### SUMMARY

It is an object of the present invention to easily determine which of transmitter's transmission abnormality or recipient's reception abnormality causes non-operation abnormality where operation of a transmitter cannot control a remote-controlled in-vehicle device.

To achieve the above object, a remote-controlled in-vehicle device in a vehicle is provided with the following. A receiving unit is included for receiving a remote-controlling wireless signal transmitted from a transmitter when a given manipulation is conducted to the transmitter, demodulating the received wireless signal, and outputting a demodulated signal representing data included in the received wireless signal. A controlling unit is included for executing a first determination of whether authentication data included in the outputted demodulated signal accords with authentication data unique to the vehicle and controlling a state of the vehicle when the first determination is affirmed. A receiving state determining unit is included for executing a second determination of whether the outputted demodulated signal is compliant with a communications rule. An analysis result storing unit is included for storing in a storage medium a result from the second determination as an analysis result for received electric waves. An analysis result outputting unit is included for outputting the stored analysis result when a request of reading out the analysis result is received from an external device.

Under the above structure, it can be easily determined without a specific wireless signal analyzing instrument whether the cause of non-operation abnormality is the functional abnormality of the receiving function of the in-vehicle device or that of the transmitting function of the transmitter.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram of a structure of a keyless entry system according to an embodiment of the present invention;

FIG. 2 is a block diagram of a receiving unit of an in-vehicle device;

FIG. 3 is a time chart of operation of the embodiment;

FIG. 4 is a table explaining analysis results stored in a storing unit;

FIG. 5 is a flow chart of process executed by a controlling unit of an in-vehicle device; and

FIG. 6 is a flow chart of process for outputting analysis results.

### DETAILED DESCRIPTION

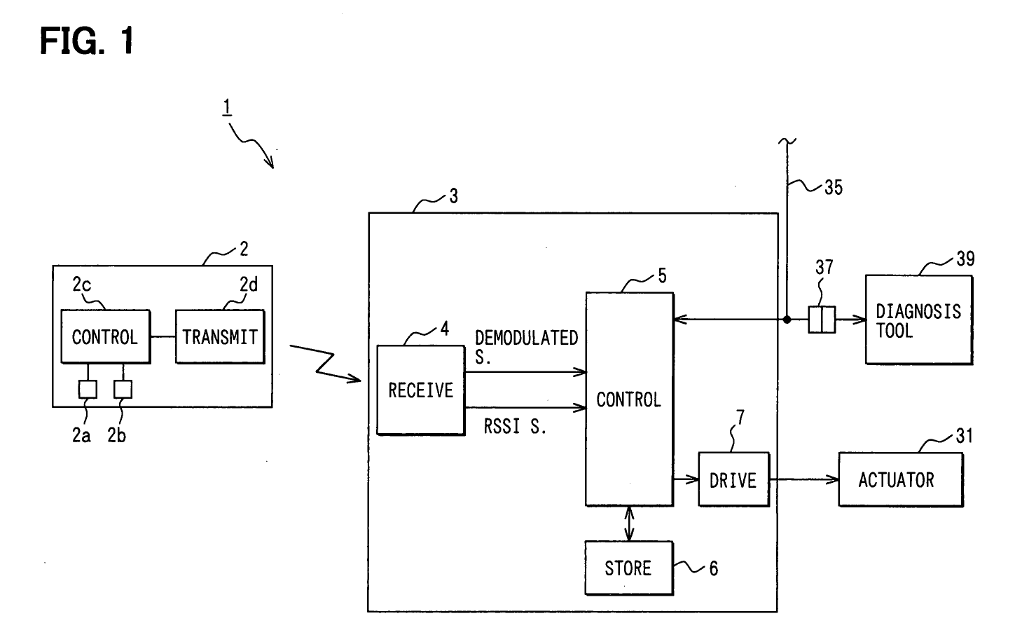

The present invention is directed to a vehicular keyless entry system as an embodiment. The keyless entry system 1 includes a transmitter 2 held by a vehicle owner, and an in-vehicle device 3 mounted in a vehicle, as shown in FIG. 1.

The transmitter 2 includes a lock button 2a for locking a vehicle door, an unlock button 2b for unlocking a vehicle door, a controlling unit 2c of a microcomputer or the like, a transmitting unit 2d for transmitting a wireless signal of a given frequency band (e.g., 315 MHz band) including transmission data given by the controlling unit 2c. When either the lock button 2a or the unlock button 2b is depressed, the controlling unit 2c outputs to the transmitting unit 2d transmission data. This transmission data includes authentication data and operation command data. The authentication data is used for authentication with the in-vehicle device 3, including an invariable ID code and a variable rolling code (RC). The operation command data indicates lock or unlock corresponding to the depressed button 2a, 2b of the two buttons 2a, 2b. The transmitting unit 2d then generates and transmits wireless signals for remote-controlling by modulating internally generated oscillating signals using the transmission data from the controlling unit 2c.

Here, the rolling code is a known variable code provided for enhancing security and is updated under a given rule, for instance, each time a user manipulates the button 2a, 2b, as described in JP-2003-248513.

The in-vehicle device 3 includes a receiving unit 4 for receiving the wireless signals from the transmitter 2, a controlling unit 5 for controlling operation of the in-vehicle device 3 itself, a storing unit 6 for storing information, and a driving circuit 7. The controlling unit 5 is, for instance, mainly formed of a microcomputer. The storing unit 6 is formed of a storage medium such as a RAM or an electrically rewritable ROM (EEPROM or flash ROM).

The in-vehicle device 3 connects to a door-lock actuator 31 for locking or unlocking a door of the vehicle. This door-lock actuator 31 is driven by the driving circuit 7 based on driving signals from the controlling unit 5. The door-lock actuator 31 is provided for each of doors of the vehicle.

In the vehicle, a communications line 35 is installed for various electronic devices to communicate with each other, and connects to the in-vehicle device 3. Furthermore, the communications line 35 connects to a diagnosis device or tool 39 as an external device for diagnosing failure of the vehicle via a connector 37. Namely, the in-vehicle device 3 is connected to the communications line 35 via the connector 37 and can thereby communicate with the diagnosis tool 39.

In the in-vehicle device 3, the receiving unit 4 receives the wireless signals from the transmitter 2, demodulates them to produce binary demodulated signals from the data included in the received signals, and outputs the produced binary demodulated signals (i.e., low level signal and high level signal).

The controlling unit 5 receives the demodulated signals from the receiving unit 4 and analyses them to determine whether the authentication data (ID code and rolling code) included in the demodulated signals accords with authentication data stored in the in-vehicle device 3 that is uniquely assigned to the vehicle where the in-vehicle device 3 is mounted. When the authentication data is determined to accord with that stored in the in-vehicle device 3, the controlling unit 5 executes either door-lock or door-unlock by driving the door-lock actuator 31 based on the operation command included in the demodulated signals along with the authentication data.

Here, each time the controlling unit 5 executes door-lock or door-unlock based on the wireless signals from the transmitter 2, the controlling unit updates the rolling code under the same rule as in the transmitter 2. Namely, the controlling unit 5 expects a rolling code that is next transmitted from the transmitter 2.

The receiving unit 4 is known as described in Patent Document 1; however, explanation will be given below to exercise more care. Here, the remote-controlling wireless signal is referred to as a command signal.

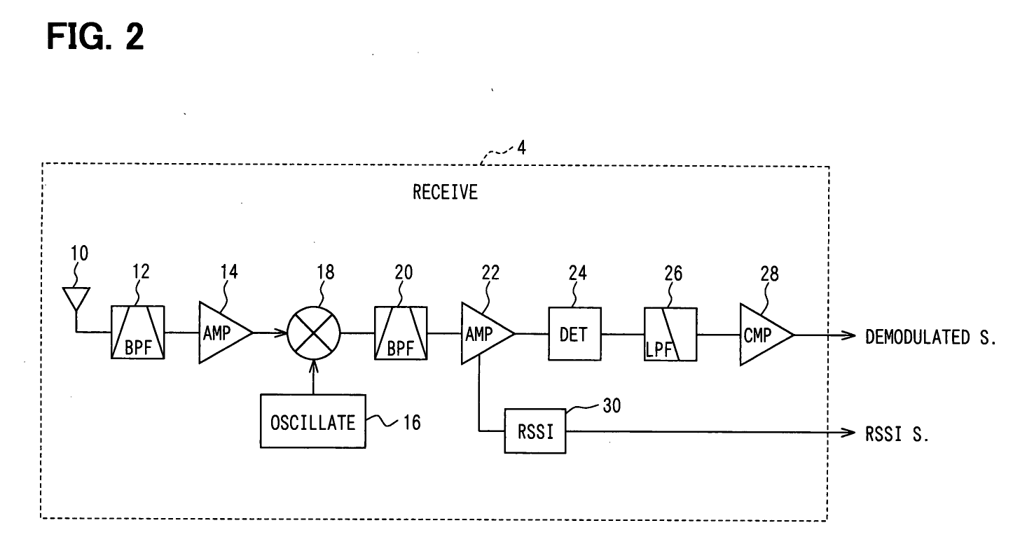

As shown in FIG. 2, the receiving unit 4 includes the following: a reception antenna 10 for receiving wireless signals; a band-pass filter (BPF) 12 for causing, among received signals via the reception antenna 10, the command signals from the transmitter 2 to selectively pass; an amplifying circuit (AMP) 14 for amplifying the command signals that have passed through the BPF 12; a local oscillator 16 for generating a high-frequency signal having a constant frequency for converting a frequency; a mixture circuit 18 for frequency converting the command signals to a given intermediate frequency band by mixing high-frequency signals from the local oscillator 16 with the command signals amplified; a band-pass filter (BPF) 20 for causing the command signals that are frequency-converted to the intermediate frequency by the mixture circuit 18 to selectively pass; an amplifying circuit (AMP) 22 for amplifying the command signals that are frequency-converted and have passed through the BPF 20; a detection circuit (DET) 24 for detecting the command signals amplified at the AMP 22; a low-pass filter (LPF) 26 for removing unnecessary high-frequency signal components from the detected command signals at the DET 24; and a comparator (CMP) 28 for outputting binary demodulated signals representing serial data included in the command signals by comparing a previously designated reference voltage with the command signals that have passed through the LPF 26.

The demodulated signals outputted from the comparator 28 are inputted to the controlling unit 5 for controlling the door-lock actuators 31.

Furthermore, in the receiving unit 4, the AMP 22 connects to an RSSI (Received Signal Strength Indicator) circuit 30 for detecting signal strength of the received signal. The RSSI circuit 30 is known to detect power consumption in the AMP 22 from an electric current amount entering the AMP 22 and output, as an RSSI signal representing the signal strength, an electric voltage signal based on the electric current amount.

As described above, the received signal frequency-converted via the BPF 20 is inputted to the AMP 22. As the inputted signal becomes small, the outputted signal becomes small to thereby decrease the power consumption of the AMP 22; in contrast, as the inputted signal becomes large, the outputted signal becomes large to thereby increase the power consumption of the AMP 22. The RSSI circuit 30 detects the power consumption of the AMP 22 from the electric current amount entering the AMP 22 and outputs to the controlling unit 5 the electric voltage signal based on the electric current amount as the RSSI signal representing the signal strength of the received signal.

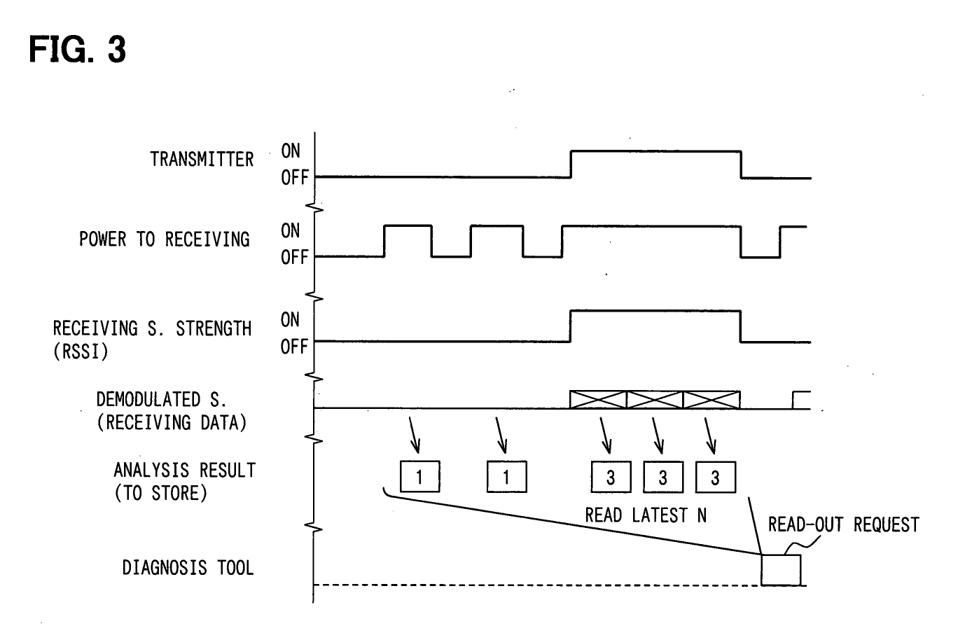

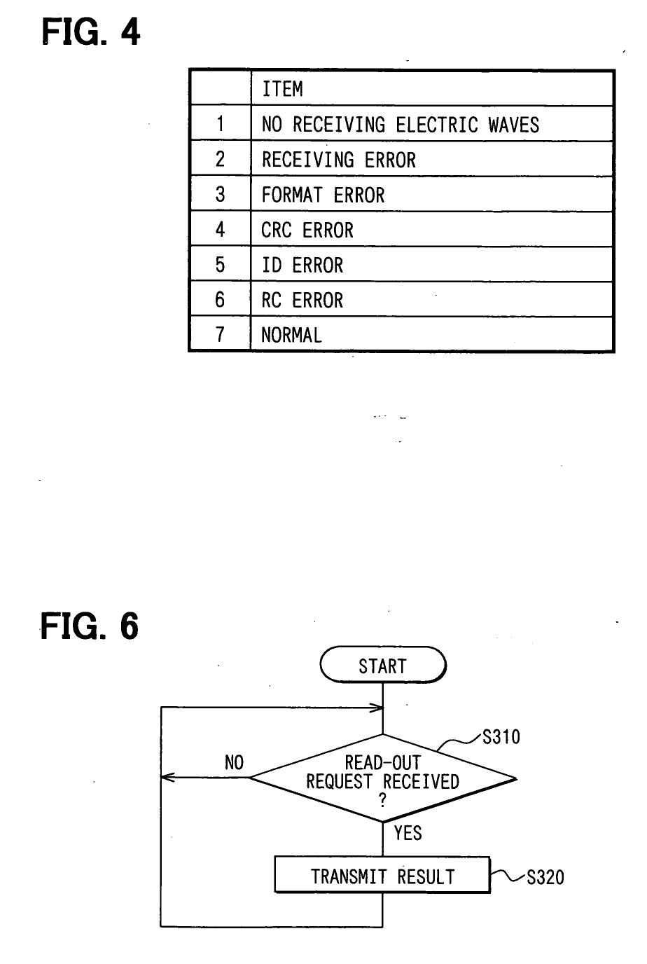

Here, the controlling unit 5 of the in-vehicle device 3 intermittently supplies the receiving unit 4 with power, as shown in FIG. 3. When an electric voltage value (hereinafter referred to as RSSI value) of the RSSI signal outputted from the receiving unit 4 is less than a given value while the power is being supplied, the controlling unit 5 determines that no received electric waves are present and then cuts off the power to the receiving unit 4. Furthermore, the controlling unit 5 simultaneously stores, in the storing unit 6, “1” representing “no electric waves are present” as an analysis result for the received electric waves.

In contrast, when the RSSI value is the given value or more while the power is being supplied, the controlling unit 5 determines that received electric waves are present and continues to supply the power to the receiving unit 4. Furthermore, the controlling unit 5 simultaneously analyzes the demodulated signal outputted from the receiving unit 4 and stores, in the storing unit 6, the resultant analysis result for the received electric waves.

In the third line of FIG. 3, “OFF” of the reception strength or RSSI indicates that the RSSI value is less than a given value, while “ON” of the reception strength or RSSI indicates that the RSSI value is the given value or more. The analysis results stored in the storing unit 6 include, in addition to the above-described “1” representing “no receiving electronic waves are present,” “2” representing “receiving error,” “3” representing “format error,” “4” representing “CRC error,” “5” representing “ID error,” “6” representing “RC (rolling code) error,” and “7” representing “normal.”

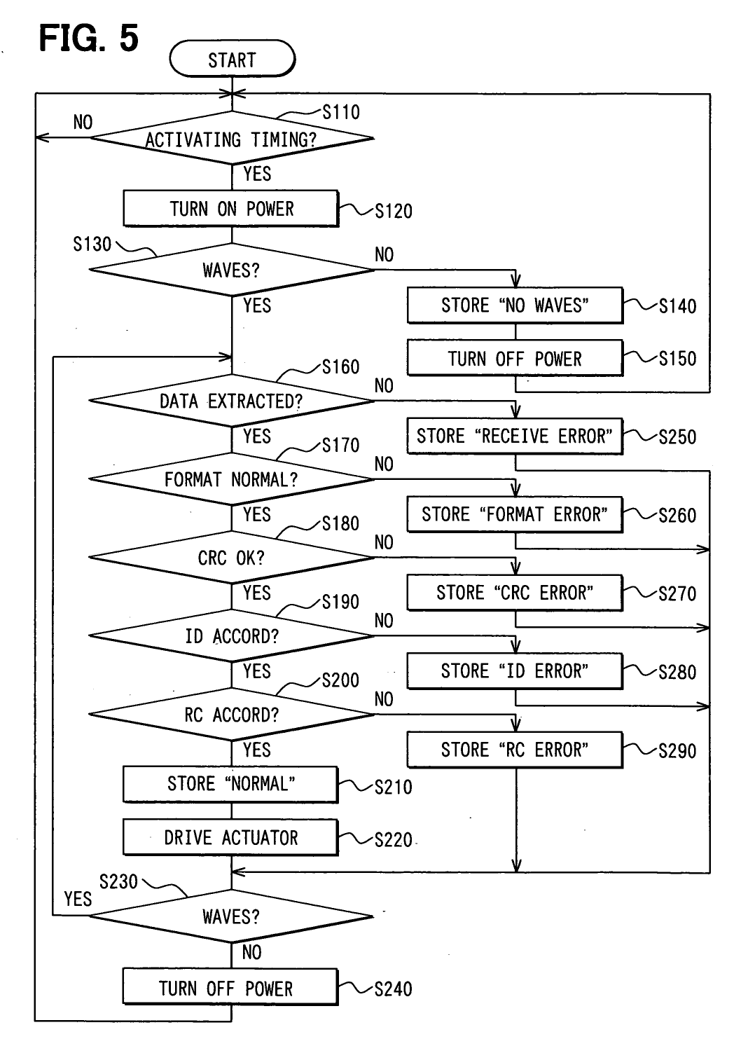

Next, process executed by the controlling unit 5 will be explained with reference to FIGS. 5, 6.

FIG. 5 is a flow chart showing process executed by the running controlling unit 5. After the controlling unit 5 starts its operation by being supplied with the power, it waits until an activating timing of the receiving unit 4 comes. When the activating timing comes, the sequence goes to STEP S120.

Here, the first activating timing of the receiving unit 4 comes when a given time Tc (e.g., 200 ms) elapses from when the controlling unit 5 starts its operation. The second timing comes when the given time Tc elapses from when the controlling unit 5 cut off the power to the receiving unit 4 at the previous timing.

At STEP S120, the controlling unit 5 turns on or starts to supply the power to the receiving unit 4. At STEP S130, the controlling unit 5 determines whether electric waves are present or not by whether or not the RSSI value becomes a given value or more.

When the received electric waves are determined to be not present at STEP S130, or when the RSSI value does not become the given value or more within the given time after the power to the receiving unit 4 is turned on (STEP S130: NO), the sequence goes to STEP S140. Here, “1” representing “no electric waves are present” is stored in the storing unit 6. At STEP S150, the power to the receiving unit 4 is turned off, which returns the sequence to STEP S110.

In contrast, when the received electric waves are determined to be present at STEP S130, or when the RSSI value becomes the given value or more within the given time after the power to the receiving unit 4 is turned on (STEP S130: YES), the sequence goes to STEP S160.

At STEP S160, the controlling unit 5 sequentially determines the demodulated signals outputted from the receiving unit 4 and determines whether one communications unit (one frame in this embodiment) is normally extracted from the demodulated signals. For instance, at STEP S160, both or one of (i) a time duration of a high level and (ii) a time duration of a low level is sequentially measured and each bit included in one frame of the received data is extracted (or restored). When the resultant measurement value falls outside of a range specified under a communications rule, the bits of the received data cannot be extracted from the demodulated signals. In this case, it is determined that the received data cannot be extracted normally.

When the received data of one frame can be extracted normally at STEP S160, the sequence goes to STEP S170. Here, it is determined whether a frame format of the received data is normal or whether the extracted received data of one frame satisfies a requirement specified in the communications rule (e.g., whether the last bit has a logical value corresponding to an end bit previously specified).

When the received data of one frame is determined to be normal at STEP S170, the sequence goes to STEP S180. Here, the received data of one frame is subjected to a known data error detection process (CRC (Cyclic Redundancy Check) in this embodiment). When a check of the CRC is successful or affirmed, the sequence goes to STEP S190.

At STEP S190, it is determined whether the ID code (hereinafter referred to as received ID code) included in the extracted received data of one frame accords with an ID code (hereinafter referred to as vehicle ID code) stored in the in-vehicle device 3. When both ID codes accord with each other (STEP S190: YES), the sequence goes to STEP S200. Here, the vehicle ID code is stored in the storing unit 6 or another storage medium.

At STEP S200, it is determined whether the rolling code (hereinafter referred to as received rolling code) included in the extracted received data of one frame accords with a rolling code (hereinafter referred to as vehicle rolling code) stored in the in-vehicle device 3. When both rolling codes accord with each other (STEP S200: YES), the sequence goes to STEP S210. Here, the vehicle rolling code is also stored in the storing unit 6 or another storage medium.

At STEP S210, the storing unit 6 is stored with “7” representing “normal” as an analysis result of the received electric waves. At subsequent STEP S220, unlocking or locking of all the doors of the vehicle are conducted based on the operation command data included in the received data of one frame above extracted. In detail, when the operation command data indicates the lock and all the doors are not locked, the door-lock actuators 31 are driven to lock all the doors. In contrast, when the operation command data indicates the unlock and all the doors are not unlocked, the door-lock actuators 31 are driven to unlock all the doors.

Next, at STEP S230, similarly to at above STEP S130, it is determined whether electric waves are present by whether the RSSI value from the receiving unit 4 is the given value or more. When the electric waves are determined to be present (STEP S230: YES), the command signals are supposed to be still transmitted sequentially from the transmitter 2, which returns the sequence to STEP S160.

When the electric waves are determined to be not present (STEP S230: NO), the sequence goes to STEP S240, where the power to the receiving unit 4 is turned off. The sequence then returns to STEP S110. After the given time Tc then elapses, the process at STEP S120 and subsequent STEPS is again executed.

Furthermore, when it is determined at STEP S160 that the received data cannot be normally extracted (or that the received data of one frame cannot be normally extracted), the sequence goes to STEP S250. Here, “2” representing “receiving error” is stored as the analysis result of the received electric waves in the storing unit 6, which advances the sequence to STEP S230.

Furthermore, when it is determined at STEP S170 that the frame format of the received data of one frame is not normal, the sequence goes to STEP S260. Here, “3” representing “format error” is stored as the analysis result of the received electric waves in the storing unit 6, which advances the sequence to STEP S230.

Furthermore, when it is determined at STEP S180 that the CRC is not successful, the sequence goes to STEP S270. Here, “4” representing “CRC error” is stored as the analysis result of the received electric waves in the storing unit 6, which advances the sequence to STEP S230.

Furthermore, when it is determined at STEP S190 that the received ID code and the vehicle ID code do not accord with each other, the sequence goes to STEP S280. Here, “5” representing “ID error” is stored as the analysis result of the received electric waves in the storing unit 6, which advances the sequence to STEP S230.

Furthermore, when it is determined at STEP S200 that the received rolling code and the vehicle rolling code do not accord with each other, the sequence goes to STEP S290. Here, “6” representing “RC error” is stored as the analysis result of the received electric waves in the storing unit 6, which advances the sequence to STEP S230.

In a case where the storing unit 6 already stores N items (N is a integer of two or more) of analysis results (or N analysis results) at a time when any one of STEPs S140, S210, S250 to S290 is executed, the oldest or earliest data item is erased and the latest data item is alternatively stored. (In other words, if the number of analysis results stored in the storing unit 6 is already N at a time when the latest analysis result is about to be stored, the earliest analysis result is then replaced with the latest analysis result. Namely, the storing unit 6 updates to store the latest N data items (or N analysis results) from the analysis results obtained from any one of STEPs S140, S210, S250 to S290.

Moreover, the controlling unit 5 of the in-vehicle device 3 executes process for outputting analysis results shown in FIG. 6, in parallel with the process in FIG. 5. Namely, as shown in FIG. 6, the controlling unit 5 waits until a read-out request from the diagnosis tool 39 connected to the communications line 35 is received at STEP S310. When the read-out request is determined to be received (STEP S310: YES), the sequence goes to STEP S320. Here, analysis results stored in the storing unit 6 are read out in an order starting from the earliest data item and sent to the diagnosis tool 39. The sequence then returns to STEP S310.

Then, the analysis results read out at STEP S320 can be displayed on a display unit of the diagnosis tool 39 in an order from the earliest data item. This displaying is performed using the diagnosis tool 39 as follows: the diagnosis tool 39 is connected to the communications line 35 using the connector 37; the read-out request is transmitted from the diagnosis tool 39; the latest N data items of the analysis results stored in the storing unit 6 of the in-vehicle device 3 are thereby read out; and the read out N data items of the analysis results are displayed on the display unit of the diagnosis tool 39.

Here, the read-out request can be diversely transmitted. Namely, each time operation of a transmission command is conducted to the diagnosis tool 39, a read-out request can be transmitted. Alternatively, after operation of a transmission start is conducted to the diagnosis tool 39, read-out requests can be repeatedly transmitted with given intervals until operation of a transmission stop is conducted.

According to the in-vehicle device 3 of the keyless entry system 1 of the embodiment, the following procedure (1) to (5) can investigate a cause of non-operation abnormality where door-lock or door-unlock does not function even when the button 2a, 2b of the transmitter 2 is manipulated. Here, the cause may be located in either the transmitting function abnormality of the transmitter 2 or the receiving function abnormality of the in-vehicle device 3.

(1) At first, a diagnosis tool 39 is connected to the communications line 35 of a subject vehicle; a button 2a, 2b of a transmitter 2 of the vehicle is manipulated; and the transmitter 2 is thereby caused to transmit to an in-vehicle device 3 of the vehicle a wireless signal (command signal) for remote-controlling.

(2) Next, a read-out request is transmitted from the diagnosis tool 39 to the in-vehicle device 3; an analysis result stored in a storing unit 6 of the in-vehicle device 3 is read out to the diagnosis tool 39; and, the read out analysis result is displayed on a display of the diagnosis tool 39 so as to be confirmed.

(3) When the analysis result shown in the display in above procedure (2) is any one of “1” “2” and “3,” (i.e., when a demodulated signal compliant with a communications rule is not outputted from a receiving unit 4 of the in-vehicle device 3), the procedure in above (1) and (2) is again conducted under a combination of the transmitter 2 of the subject vehicle and a given in-vehicle device 3 of which functional normality is confirmed and which is mounted in another given vehicle having a keyless entry system of the embodiment.

(4) When an analysis result read out from the given in-vehicle device 3 of the given vehicle indicates the same result (any one of “1” “2” and “3”) as that of the in-vehicle device 3 of the subject vehicle, the transmitting unit 2d of the transmitter 2 is determined not to normally function. Thus, the transmitter 2 should be replaced or repaired.

(5) In contrast, when an analysis result read out from the given in-vehicle device 3 of the given vehicle does not indicate the same result (any one of “1” “2” and “3”) as that of the in-vehicle device 3 of the subject vehicle, the receiving unit 4 of the in-vehicle device 3 of the subject vehicle is determined not to normally function. Thus, the in-vehicle device 3 of the subject vehicle should be replaced or repaired.

Here, within the procedure (3), operation of (1) and (2) can be alternatively conducted under a combination of a transmitter 2, of which functional normality is confirmed, of another given vehicle and the in-vehicle device 3 of the subject vehicle. Namely, in this case, when an analysis result read out from the in-vehicle device 3 of the subject vehicle indicates the same result (any one of “1” “2” and “3”), the receiving unit 4 of the in-vehicle device 3 of the subject vehicle is determined not to normally function. Vice versa, when an analysis result read out from the in-vehicle device 3 of the subject vehicle does not indicate the same result (any one of “1” “2” and “3”), the transmitting unit 2d of the transmitter 2 is determined not to normally function.

Thus, according to the in-vehicle device 3 of the keyless entry system of the embodiment, it can be easily determined without a specific wireless signal analyzing instrument whether the cause of non-operation abnormality is the functional abnormality of the receiving function of the in-vehicle device 3 or that of the transmitting function of the transmitter 2.

Furthermore, in the in-vehicle device 3 of the embodiment, when the data format is determined to be normal at STEP S170 and then the check result of the CRC is not OK at STEP S180, “CRC error” is stored in the storing unit 6 as the analysis result at STEP S270. Therefore, it is conveniently determined whether the cause of the non-operation abnormality is a communications error (data change) or not.

Furthermore, in the in-vehicle device 3 of the embodiment, when the determinations at all STEPs S130, S160, and S170 are affirmed (i.e., the receiving unit 4 is determined to output modulated signals compliant to the communications rule), and also when the check result of CRC is determined to be successful, an authentication determination result at STEPs S190, S200 is stored in the storing unit 6 as the analysis result of the received electric waves at STEPs S210, S280, S290.

This makes easy the determination of the cause of the non-operation abnormality when the cause is relating not to the wireless communications, but to an external output line (i.e., driving circuit 7 or door-lock actuator 31) from the controlling unit 5 of the in-vehicle device 3.

That is, there may be a case where an analysis result read out from the in-vehicle device 3 indicates “7” in the above procedure (2). In this case, since the authentication determination was already affirmed (or OK), it can be determined that there is no functional abnormality relating to the wireless communications or the authentication determination but there is abnormality relating to the external output line from the controlling unit 5 of the in-vehicle device 3. Furthermore, in this case, the received ID code or the received rolling code from the transmitter 2 or the vehicle ID code or the vehicle rolling code stored in the in-vehicle device 3 are not disclosed to the diagnosis tool 39, so that confidentiality can be maintained.

Further, there may be a case where an analysis result read out from the in-vehicle device 3 indicates “5” or “6” in the above procedure (2). In this case, it can be determined that there is no functional abnormality relating to the transmitting function of the transmitter 2 or the receiving function of the in-vehicle device 3. Alternatively, it can be determined that the transmitter 2 transmits wireless signals including the wrong authentication data or the authentication determination is not normally executed in the controlling unit 5 of the in-vehicle device 3. Therefore, in this case, for instance, both the transmitter 2 and the in-vehicle device 3 can be replaced.

Furthermore, in the in-vehicle device 3 of the embodiment, the latest N analysis results are stored in the storing unit 6 and these N analysis results stored in the storing unit 6 are replied according to one read-out request. Therefore, even when an interval for transmission from the diagnosis tool 39 is long, multiple analysis results can be retrieved without omission, which helps prevent the analysis result from disappearing without being retrieved.

(Other Modifications)

In the above embodiment, the RSSI circuit 30 that detects the signal strength of the received signal from the consumed electric currents of the AMP 22 is used for detecting the signal strength of the received signal in the receiving unit 4. However, detecting the signal strength of the received signal can be detected by another circuit. This circuit detects the received signal after the frequency-conversion, outputted from the BPF 20 and detects the voltage level after detecting waves.

Furthermore, in the above embodiment, the diagnosis tool 39 is used as the external device. The diagnosis tool 39 is typically provided in a car dealer or the like for diagnosing a vehicle under maintenance or repair. However, the external device can be a device dedicated for determining the cause of non-operation abnormality in the remote-controlled in-vehicle device and the corresponding transmitter.

Furthermore, in the above embodiment, the present invention is adapted to an in-vehicle device for a keyless entry system. However, the present invention can be adapted to any in-vehicle device as long as this in-vehicle device is used for remote-controlling, obtaining the same effect. For instance, the in-vehicle device can be a system that activates an engine of a vehicle by remote-controlling. Alternatively, the in-vehicle device can be a system that activates various auxiliary in-vehicle devices such a navigation device.

A process shown in the above may be executed using a CPU, a ROM, and the like. Here, steps in the process may be constructed as means or units in program stored in the ROM or the like.

It will be obvious to those skilled in the art that various changes may be made in the above-described embodiments of the present invention. However, the scope of the present invention should be determined by the following claims.

What is claimed is:

1. A remote-controlled in-vehicle device provided in a vehicle, the device comprising:
a receiving unit for receiving a remote-controlling wireless signal transmitted from a transmitter when a given manipulation is conducted to the transmitter, demodulating the received wireless signal, and outputting a demodulated signal representing data included in the received wireless signal;
a controlling unit for executing a first determination of whether authentication data included in the outputted demodulated signal accords with authentication data unique to the vehicle, and for controlling a state of the vehicle when the first determination is affirmed;
a receiving state determining unit for executing a second determination of whether the outputted demodulated signal is compliant with a communications rule;
an analysis result storing unit for storing in a storage medium a result from the second determination as an analysis result for received electric waves; and
an analysis result outputting unit for outputting the stored analysis result when a read-out request of reading out the analysis result is received from an external device.

2. The remote-controlled in-vehicle device of claim 1,
wherein when the receiving state determining unit determines that the outputted demodulated signal is compliant with the communications rule, the analysis result storing unit stores, as an analysis result for received electric waves, a result from the first determination.

3. The remote-controlled in-vehicle device of claim 1,
wherein the storage medium is updated to store N pieces of analysis results from a latest analysis result, wherein N is two or more, and
the analysis result outputting unit outputs the stored N pieces of analysis results when a read-out request is inputted.

4. The remote-controlled in-vehicle device of claim 1,
wherein the external device includes a diagnosis device to execute a diagnosis for the vehicle.

5. The remote-controlled in-vehicle device of claim 1,
wherein the controlling unit controls door-lock or door-unlock of doors of the vehicle as the state of the vehicle.
